(19) United States
(12) Patent Application Publication
(10) Pub. No.: US 2002/0018983 A1
(43) Pub. Date: Feb. 14, 2002

(54) System and method of teaching typing with a computer game

(76) Inventor: Peter O. Dixon, Phoenix, AZ (US)

Correspondence Address: Laura J. Zeman, SNELL & WILMER, L.L.P., One Arizona Center, 400 East Van Buren, Phoenix, AZ, 85004-2202, US

(21) Appl. No.: 09/793,230

(22) Filed: Feb. 26, 2001

Related U.S. Application Data
(60) Provisional application No. 60/184,763, filed on Feb. 24, 2000.

(51) Int. Cl. G09B 13/00

(52) U.S. Cl. 434/227

(57) ABSTRACT

A system and method for teaching typing using a computer game. The computer game may take many forms and may provide both audio and/or visual instructions as well as audio and/or visual responses to a user's input.

### CROSS-REFERENCE TO RELATED APPLICATIONS

This application claims the benefit of U.S. Provisional Application No. 60/184,763, filed Feb. 24, 2000, which is incorporated herein by reference.

### FIELD OF THE INVENTION

The invention relates generally to systems and methods for teaching typing. More particularly, the invention relates to systems and methods for teaching typing using a computer game.

### BACKGROUND OF THE INVENTION

Various methods of teaching typing skills are known in the prior art. For example, U.S. Pat. No. 5,314,337 entitled “Color-Coded Data Input System Method and Apparatus”, issued on May 24, 1994 to Peter O. Dixon and incorporated herein by reference in its entirety, describes a technique for teaching typing based upon color codes. Other programs for teaching typing include the “Mavis Bacon Teaches Typing” program available from the Softkey International Corporation.

### SUMMARY OF TFIE INVENTION

A system and method for teaching typing are presented which include 1) pre-assigning fingers to match keys on a keyboard, 2) pre-assigning like colors to matching fingers and keys, 3) providing a set of letters, words, phrases or sentences for learning how to type; 4) displaying a letter, word, phrase or sentence on a screen, 5) allowing a user to depress the proper key with the proper pre-assigned finger, 6) determining if the proper key was depressed, 7) providing video and/or audio acknowledgement for a correct depression or an audio and/or visual clue in response to an incorrect depression, and 8) repeating steps 5 through 7 until the user either achieves a correct depression or accumulates a predetermined number of incorrect depressions to end the lesson or game.

In one aspect of the present invention, the system and method for teaching typing are in the form of a computer game. Ideally, the speed of the game adjusts to suit the user without having to change speed settings. For example, upon beginning the game, a user may select a beginner, intermediate, or advanced stage. Once the selection is made and the game begins, a letter, word, phrase, or sentence to be typed will be presented and directions/clues will be given to direct the user to typing the proper key with the proper finger. The directions/clues will begin even if the user fails to immediately enter a keystroke. In the beginner version, the directions/clues will be very explicit and response time will allow the directions/clues to be introduced both visually and by audio. The intermediate level may allow sufficient time for the directions/clues to be given in an abbreviated version by audio and visually. By the time a user reaches the advanced stage, the directions/clues will come more quickly such that there may only be time for allowing the directions/clues to be given visually on the screen.

A computer game using the system and method of the present invention may take many forms. For example, the computer game may be directed to the user functioning as the commander of a spaceship looking out a viewing port. The letter, words, phrases or sentences to be learned for typing may be presented as asteroids which can crack or damage the viewing port if they are not obliterated before reaching the viewing port. When a user depresses the correct key, the letter, word, phrase or sentence to be learned may be destroyed or obliterated by a laser or some other weapon means (by both visual and audio effects). Alternatively, if the correct key is not depressed within a the given time period of the instructions/clues, the asteroid may hit the viewing port and crack or damage it. Once the viewing port is hit a predetermined number of times, the viewing port is destroyed and the game is over.

In another aspect of the invention, a shield may be used to cover the keys on a keyboard with the topside of the shield representing a keyboard having the keys colored in the pre-assigned colors associated with the proper fingers that are to be used for depressing the keys. During use, the user sees the top of the shield and places their hands on the shield. the keys may be felt beneath the shield and certain keys may have different textured surfaces to enhance the tactile sense of correct finger placement on the keys.

### BRIEF DESCRIPTION OF THE DRAWING FIGURES

The present invention will hereinafter be described in conjunction with the appended drawing figures, wherein like numerals denote like elements, and:

FIG. 1 is an exemplary display screen image showing the fingers of both right and left hands assigned to various color codes;

FIG. 2 is an exemplary display screen image showing color coding for fingers of the right and left hands, color coding for keys on a keyboard, and a view port;

FIGS. 3-5 show exemplary display screen images where different features depicted on the screen image are flashed so that a user's attention is called to those features, i.e., in FIG. 4 the left hand is flashed and in FIG. 5 the right hand is flashed;

FIGS. 6-10 illustrate exemplary display screen images showing which fingers are associated with which keys on the keyboard by way of color coding;

FIGS. 11-13 illustrate exemplary display screen images showing the three typing positions (reach, home row and pull back) for the fingers to reach the keys on the keyboard;

FIG. 14 shows an exemplary display screen image of a “next column” position illustrated by showing a ghost image of a finger and/or color to the side of the hand images;

FIG. 15 illustrates an exemplary display screen image that would be seen at the beginning of a game played in accordance with the method of the present invention;

FIGS. 16-18 illustrate exemplary display screen images of the introduction of a letter “w” to be learned for typing on a keyboard;

FIGS. 19-20 illustrate exemplary display screen images for teaching which hand should be used for typing the letter “w”;

FIGS. 21-23 illustrate exemplary display screen images for teaching which finger of the left hand should be used for typing the letter “w”;

FIGS. 24-26 illustrate exemplary display screen images for teaching the location of the key to be used for typing the letter “w”;

FIGS. 27-30 illustrate exemplary display screen images showing the location of the key for typing the letter “w” as well as the hand and finger which should be used while the displayed image of the letter “w” grows larger to allow the used time to properly type the key;

FIG. 31 shows an exemplary display screen image which results when the letter “w” is properly typed which in this case removes the “w”;

FIG. 32 shows an exemplary display screen image which enables a user to practice the typing just learned by repeating the proper typing of the letter “w”;

FIG. 33 is a flowchart showing an exemplary method of the present invention for teaching typing using a computer game; and

FIG. 34 is a block diagram of a computer system used to carry out the method of the present invention.

### DETAILED DESCRIPTION OF EXEMPLARY EMBODIMENTS

The present invention may be described herein in terms of functional block components and various processing steps. It should be appreciated that such functional blocks may be realized by any number of analog, hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, PASCAL, Java, assembler, PERL, PHP, any database programming language or the like, with the various algorithms being implemented with any combination of data structures, objects, processes, routines or other programming elements. Similarly, the invention could be used in conjunction with any type of personal computer, network computer, workstation, minicomputer, mainframe, or other computer running any version of Windows, MacOS, BeOS, Linux, UNIX, Solaris or any other operating system. Further, it should be noted that the present invention might employ any number of conventional techniques for data transmission, signaling, data processing, network control, and the like. For example, radio frequency (RF) or other wireless techniques could be used in place of any network technique described herein. Moreover, although the invention is frequently described herein as being implemented with TCP/IP communications protocols, it will be readily understood that the invention could also be implemented using IPX, Appletalk, IP-6, NetBIOS, OSI or any number of existing or future protocols.

It should be appreciated that the particular implementations shown and described herein are illustrative of the invention and are not intended to limit the scope of the invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical audio content promotion system.

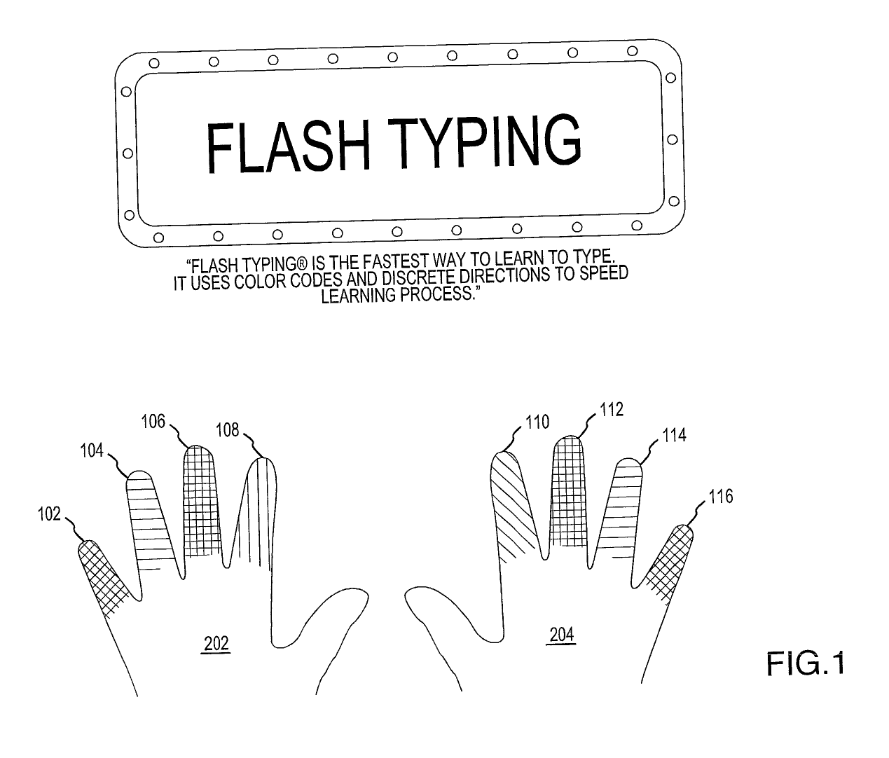

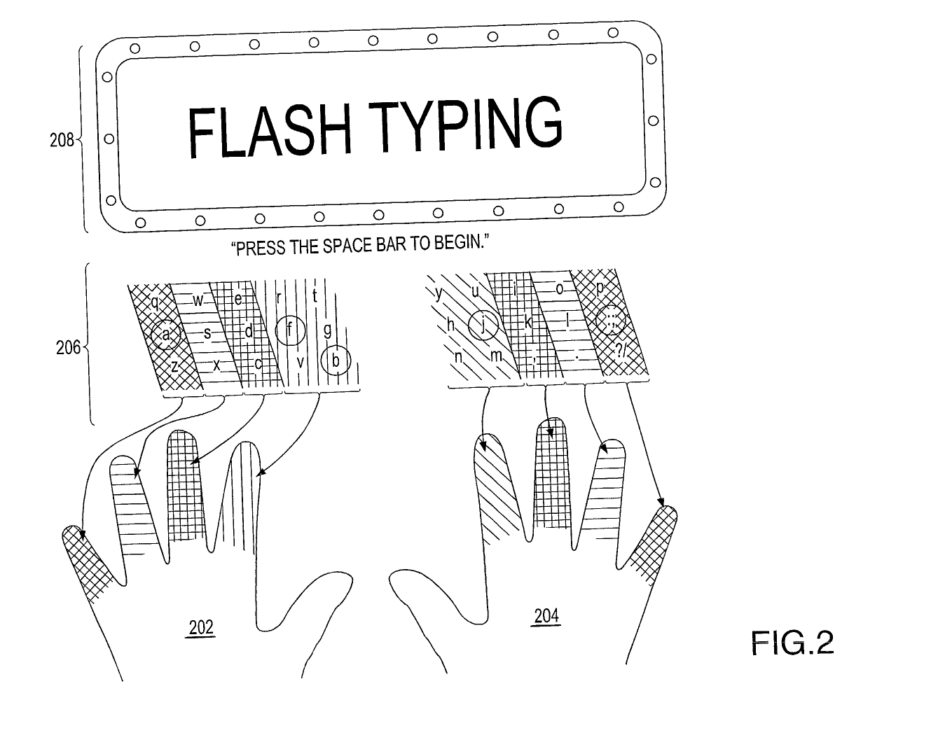

The “Flash Typing” method of teaching typing is described in detail in U.S. Pat. No. 5,314,337. Various embodiments of the present invention incorporate the Flash Typing method into a game that is entertaining and educational, especially for children. In the Flash Typing method, fingers and keys are assigned to various color codes. For example, (and with reference to FIG. 1) the fingers of the left hand 102, 104, 106 and 108 (beginning with the smallest finger and proceeding to the index finger) may be assigned to orange, blue, yellow and red, respectively. The fingers 110, 112, 114 and 116 of the right hand (beginning with the index finger and proceeding to the smallest finger) may be assigned to green, yellow, blue and orange, respectively. Of course other embodiments may use other color schemes. The various colors may also be assigned to keys on the typewriter (or computer) keyboard, as shown in FIG. 2, such that fingers are associated with keys by a common color.

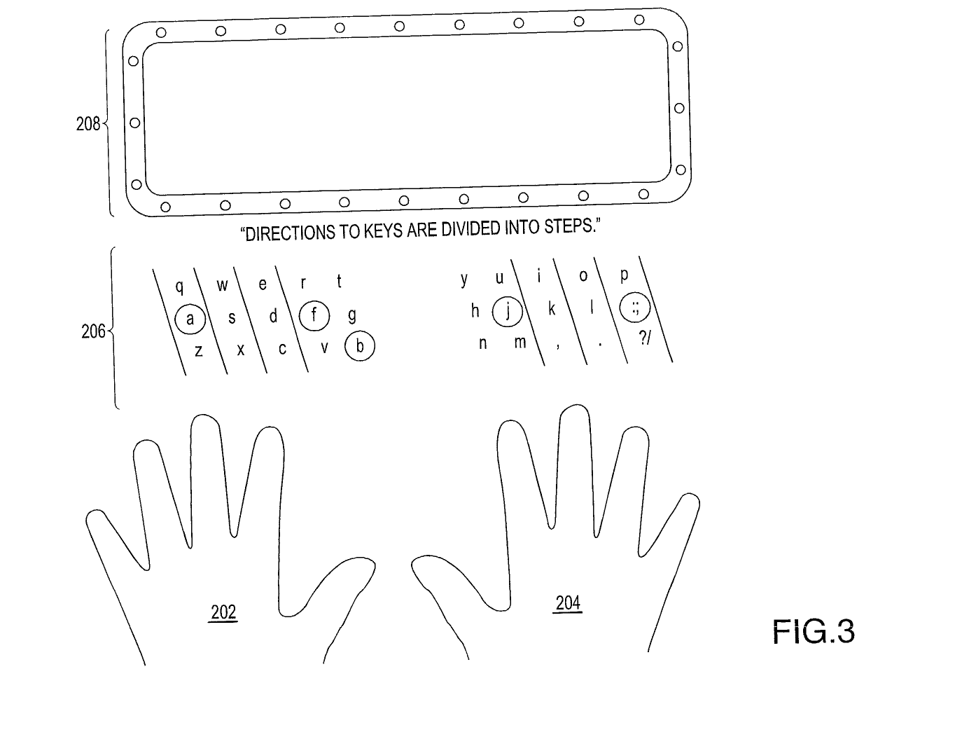

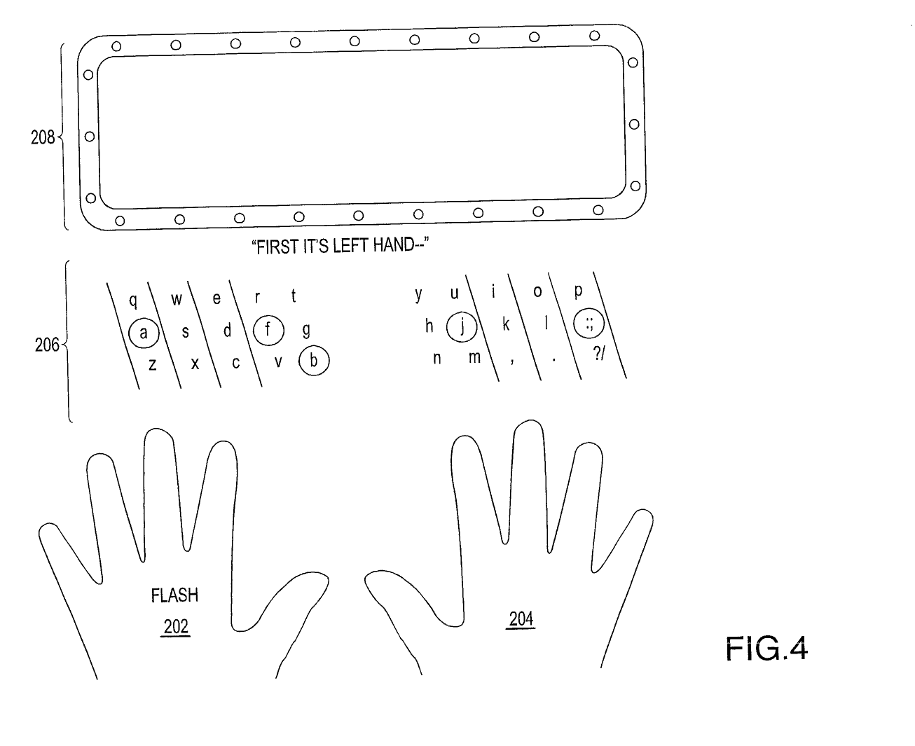

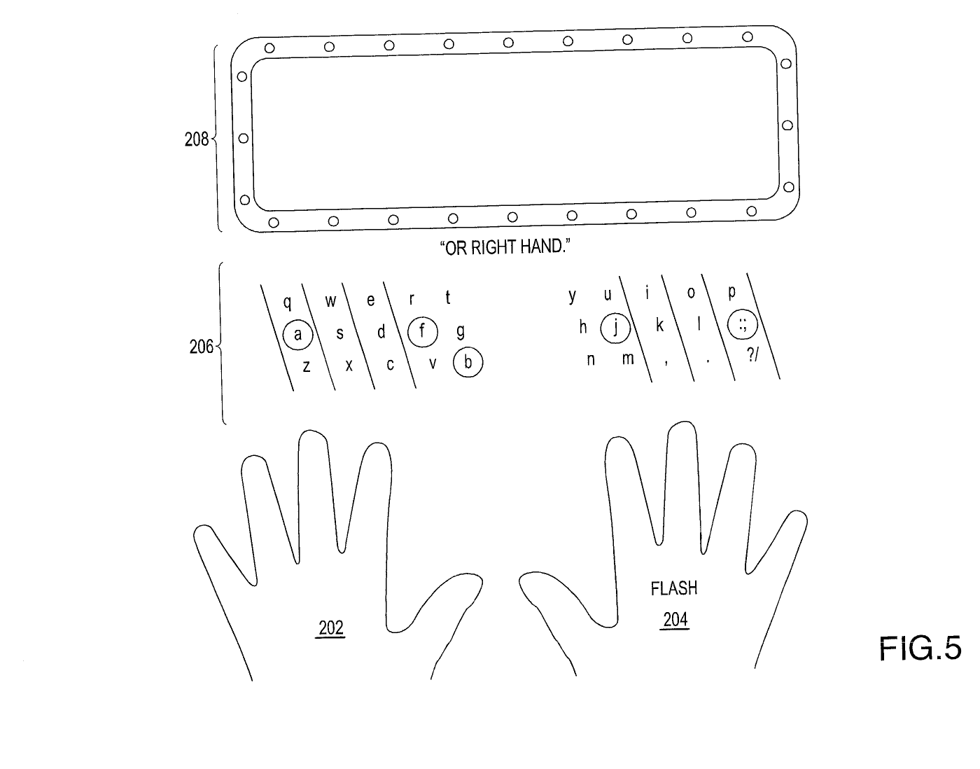

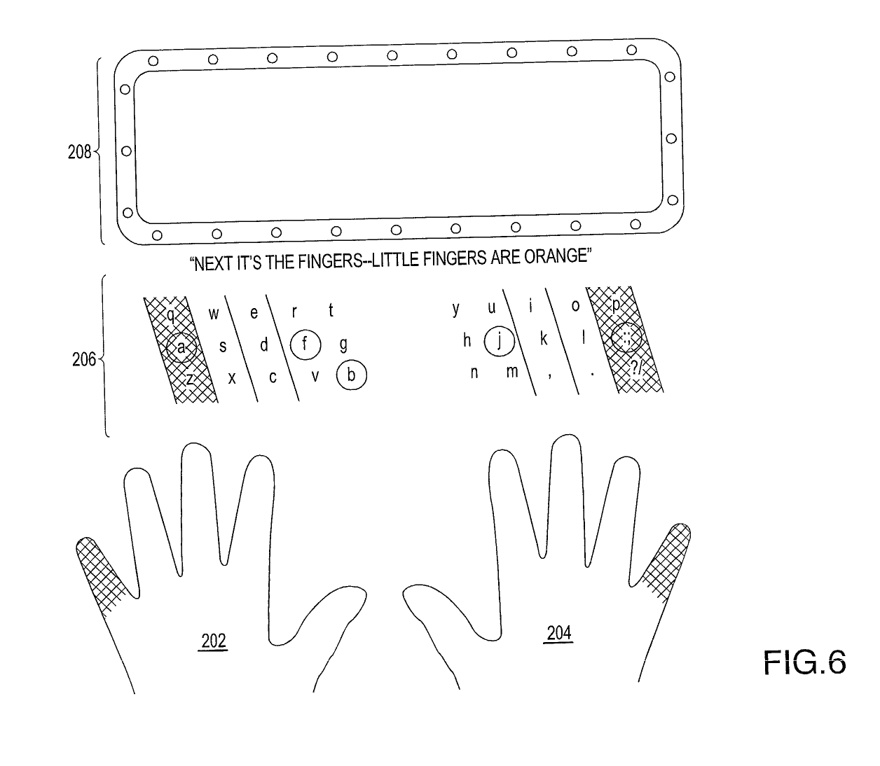

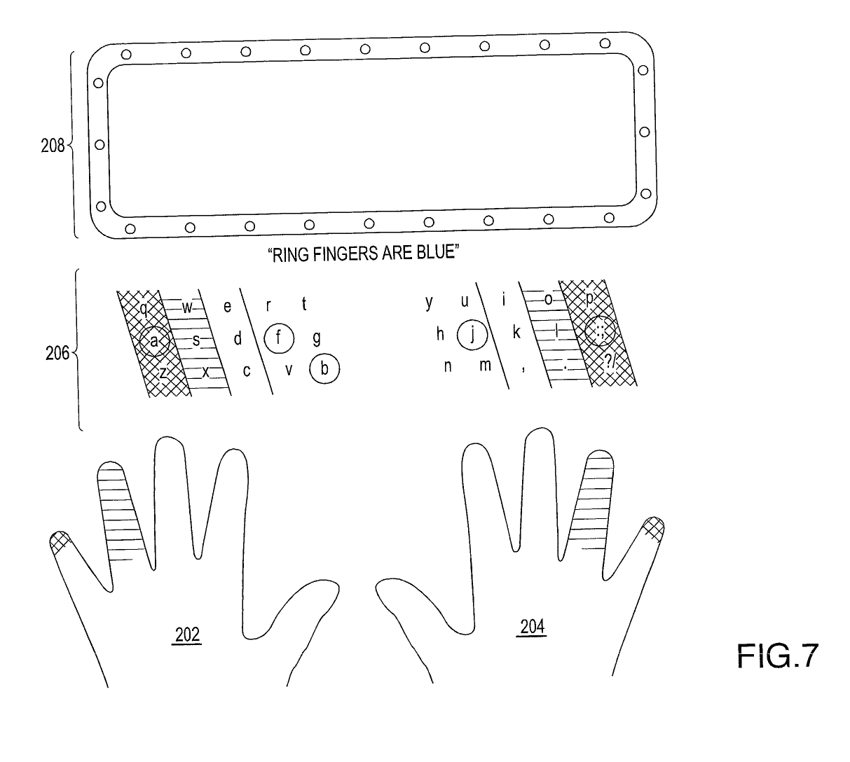

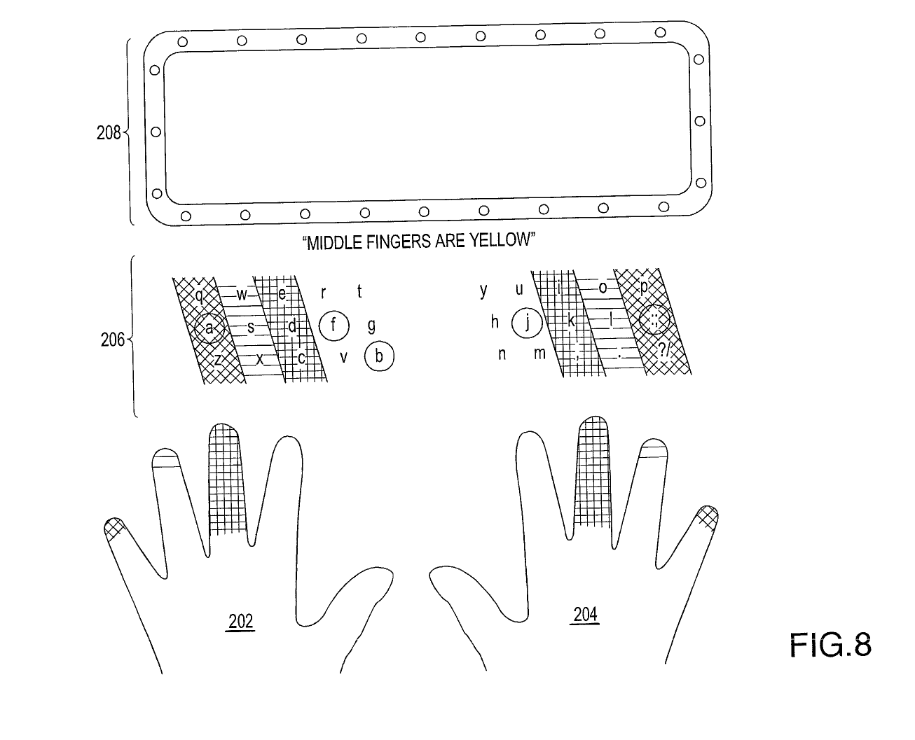

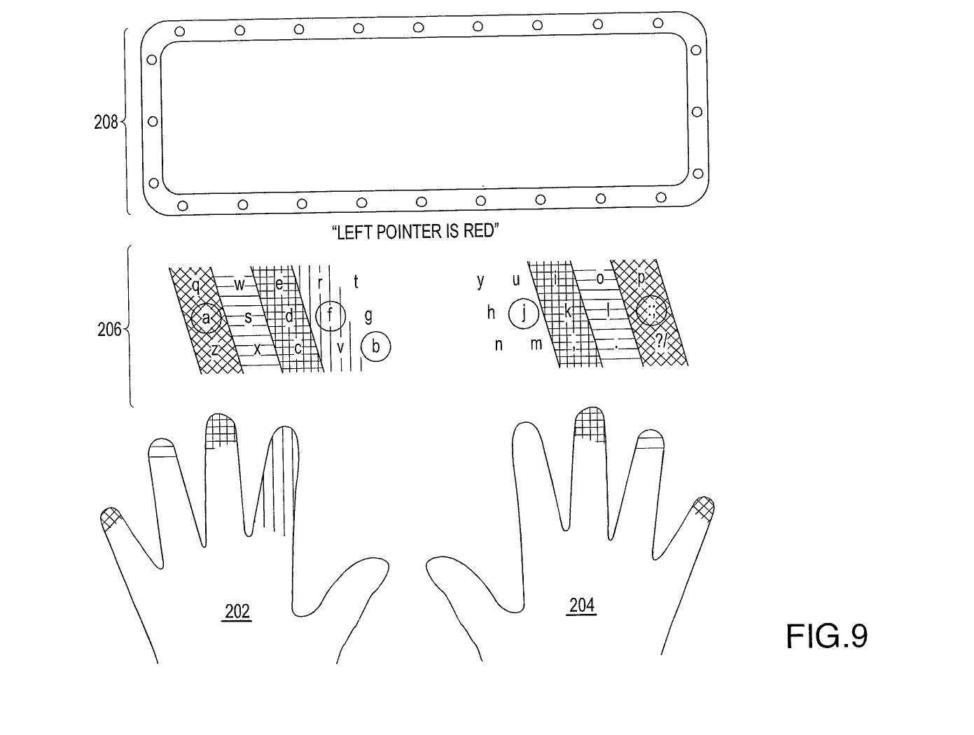

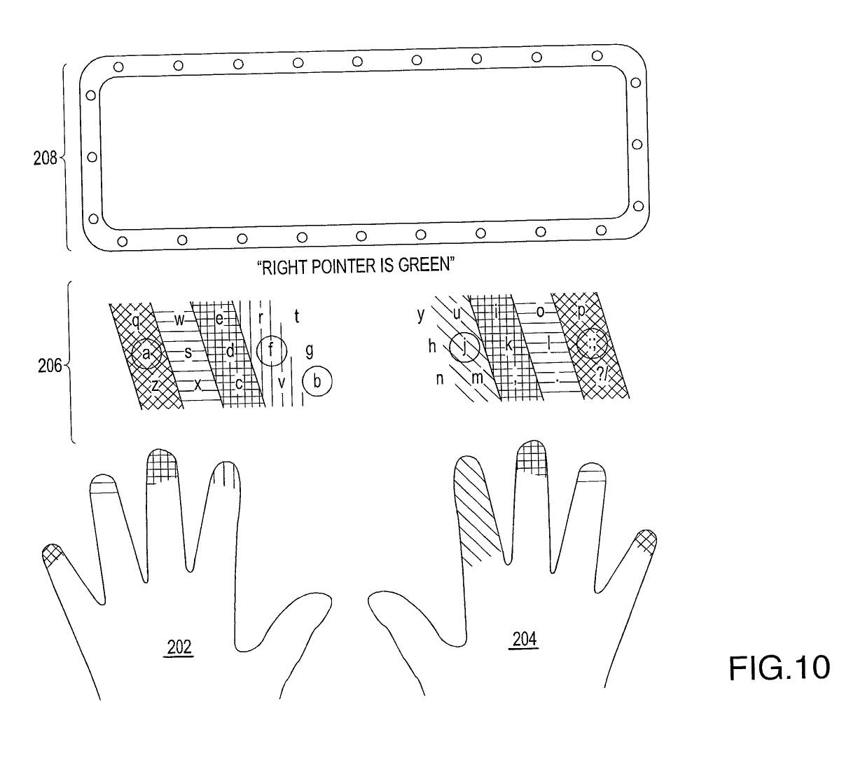

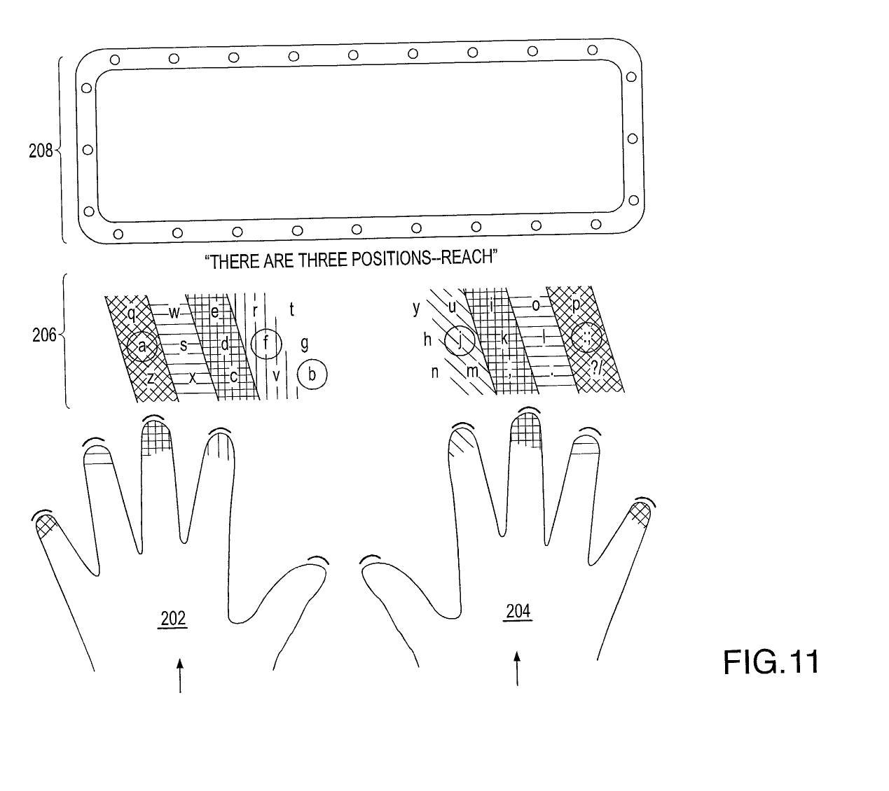

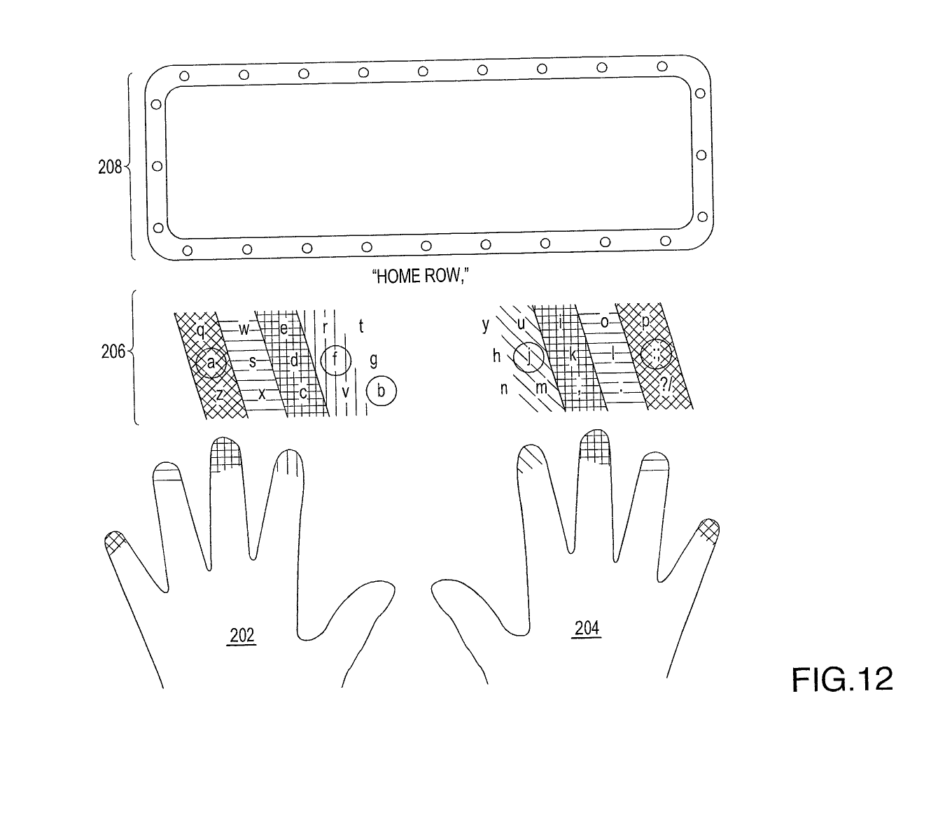

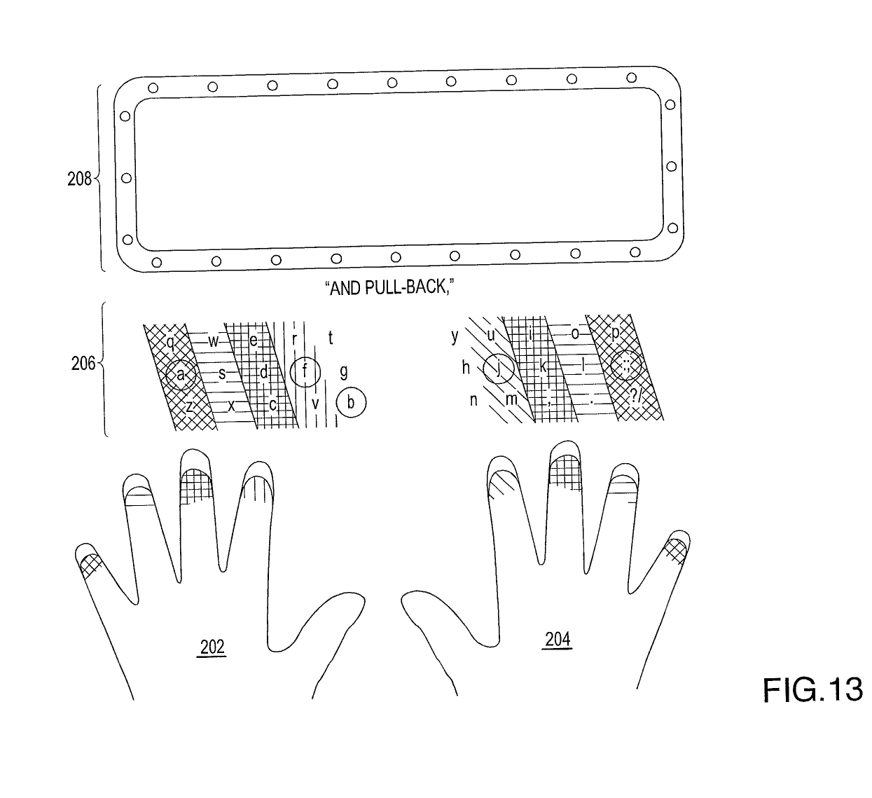

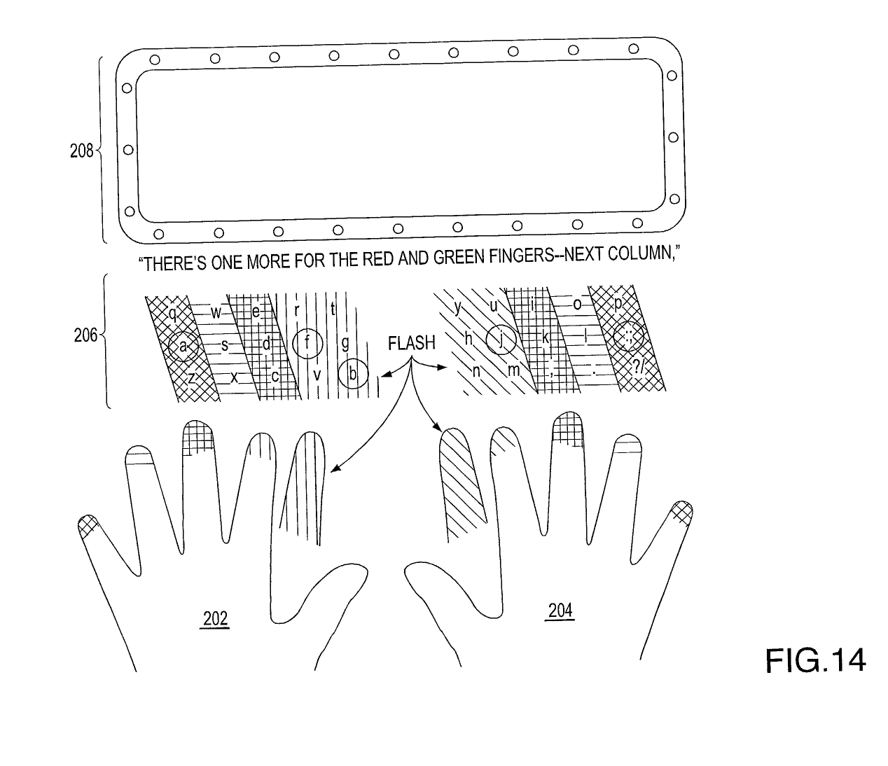

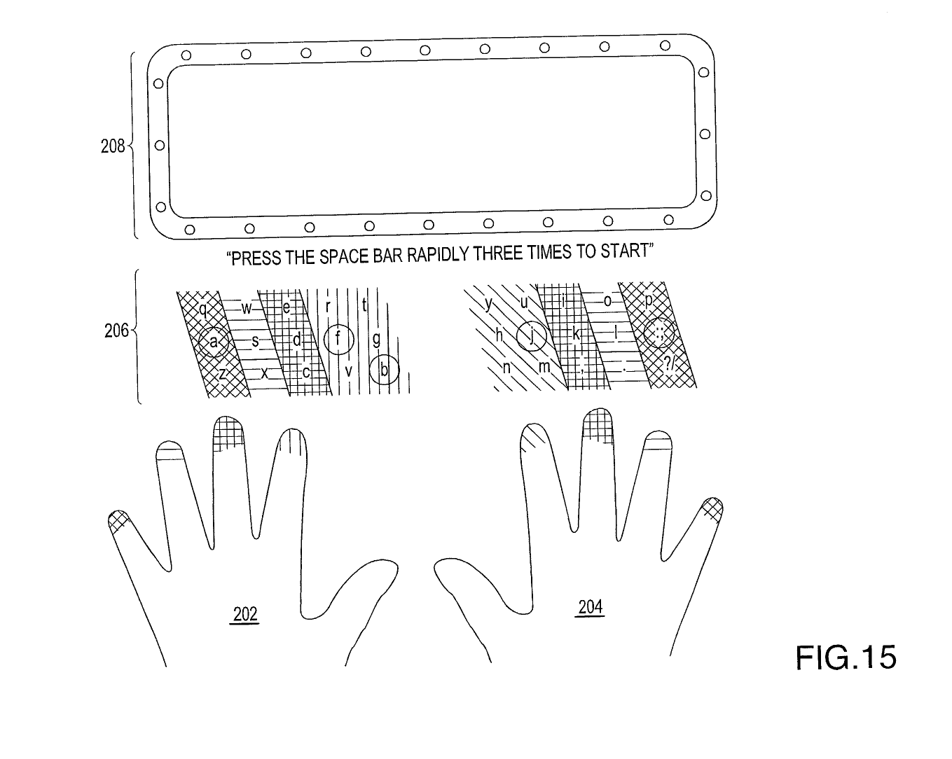

The various Figures show exemplary images that may be shown on a display screen including left hand 202, right hand 204, keys 206 and viewing port 208 (see, e.g., FIG. 2). Instructions for playing an exemplary game are shown in FIGS. 3-14. Fingers are assigned to various keys, as shown. As the left and right hand are introduced by a synthesized voice, onscreen text, or another technique, the relevant hand image 202 or 204 may flash (FIGS. 4 and 5, respectively). Fingers may be introduced (as in FIGS. 6-10) by flashing the fingers on the screen, or coloring the finger images on screen with the appropriate color, as shown. Three typing positions (reach, home row and pull back) may also be introduced by altering the hand images, as shown in FIGS. 11-13. “Next column” positions may also be introduced as shown in FIG. 14 by drawing a “ghost image” of a finger or a color to the side of the hand images, or by any other technique.

Various embodiments of the software are designed to teach a discrete set of directions, starting from the home row, to other keys by using the movement of an “asteroid” and “laser tire” to indicate to the student where the correct key is located. The game has the student looking out a “viewing port” 208 from the flight deck of a space ship that has encountered an asteroid field as it is traveling through “space.” In various embodiments, a laser beam, projectile or other object is “launched” at the letter as the player depresses a key on the keyboard. If the key depressed properly corresponds to the letter displayed on the viewing port, the “asteroid” displaying the letter may be destroyed by the “laser” beam. If an incorrect key is depressed, the laser beam may miss the asteroid, and the asteroid will continue toward its eventual position, as described below. Points may be awarded for the speed with which the player depresses the proper key to destroy the asteroid in various embodiments.

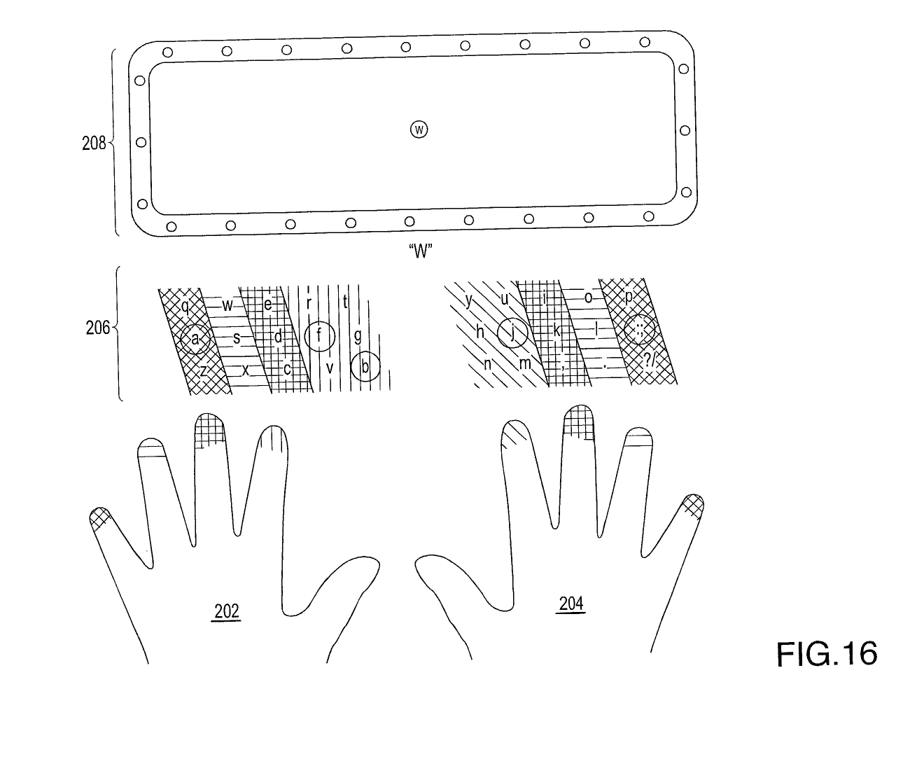

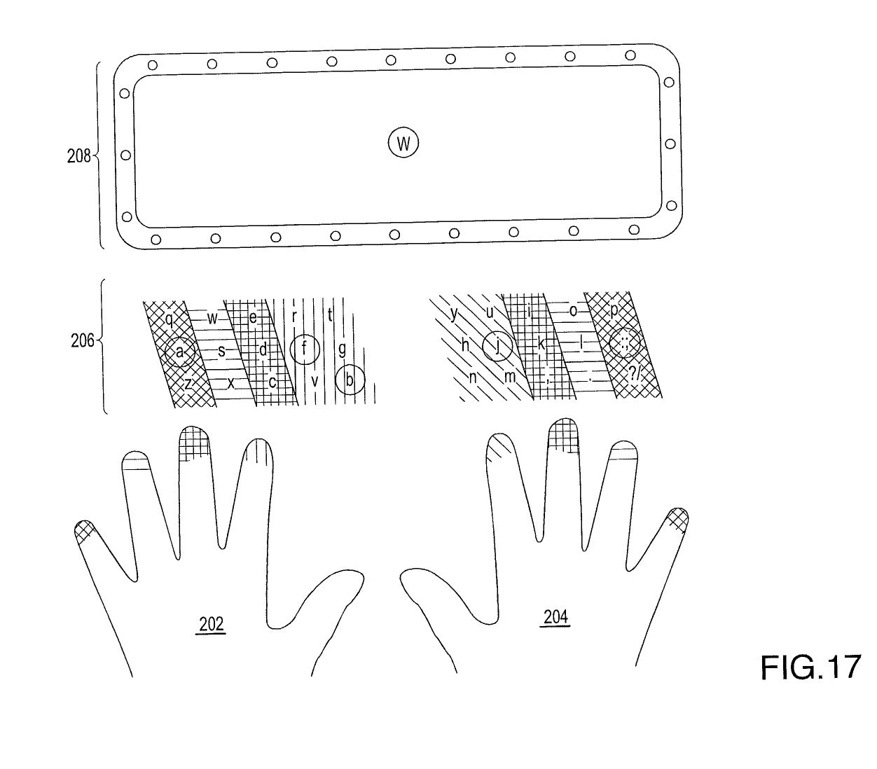

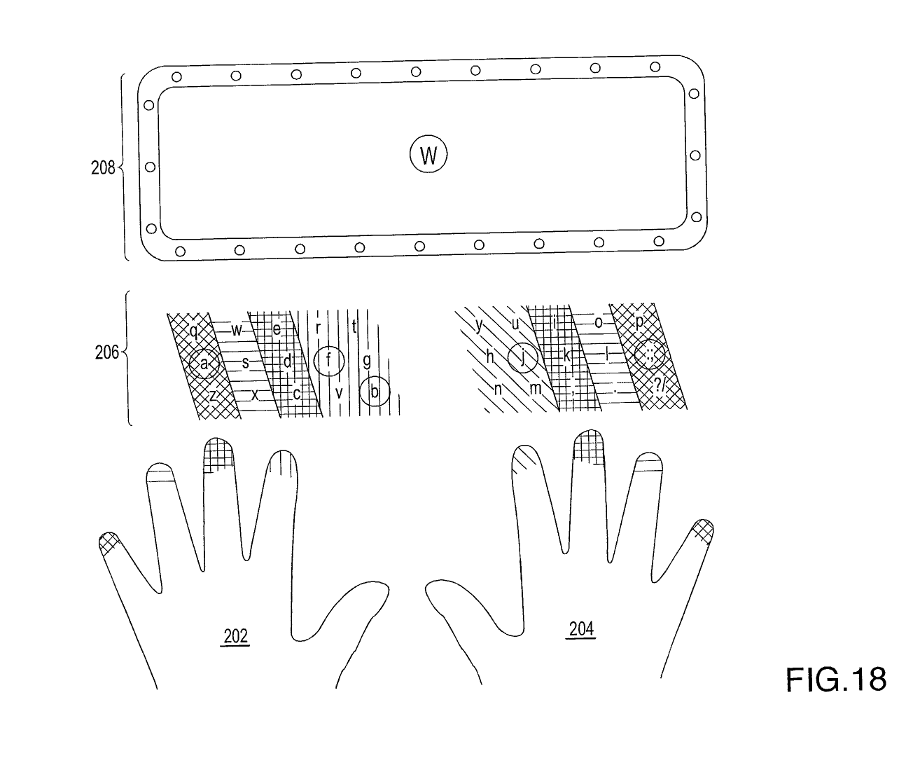

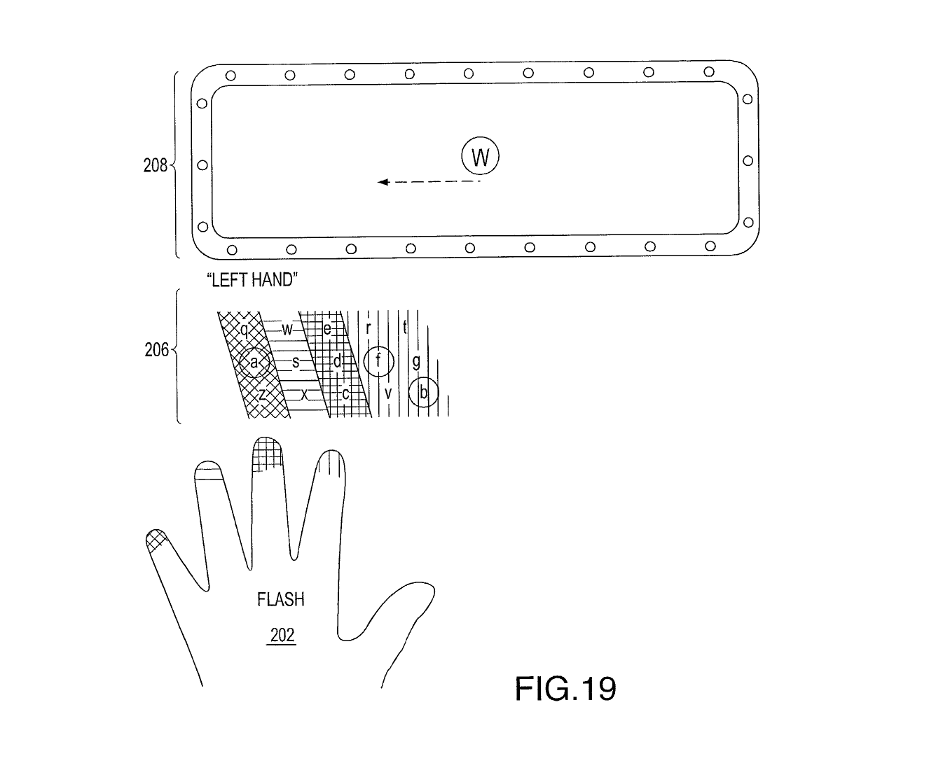

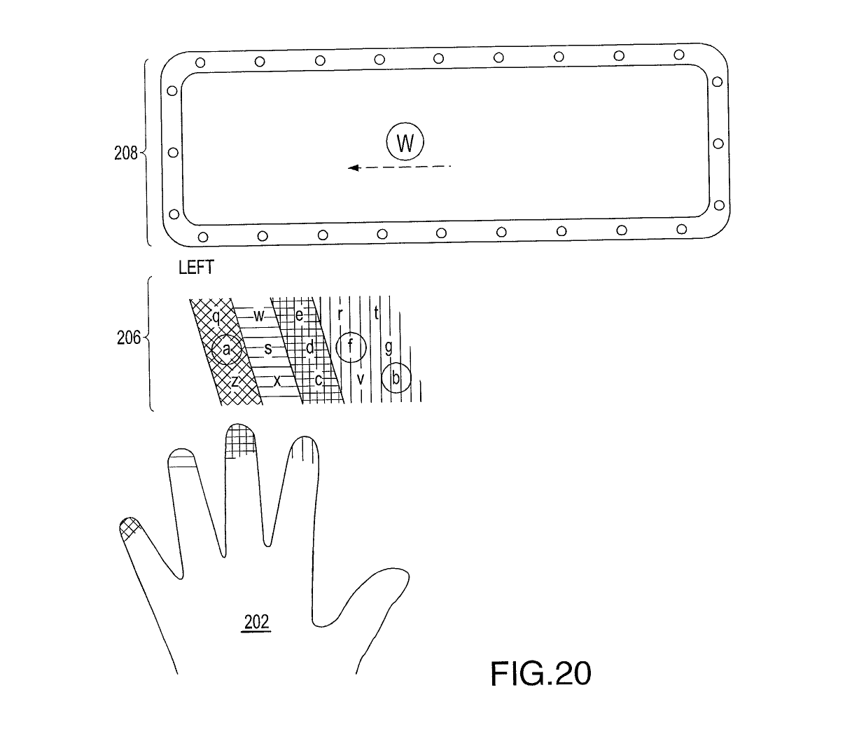

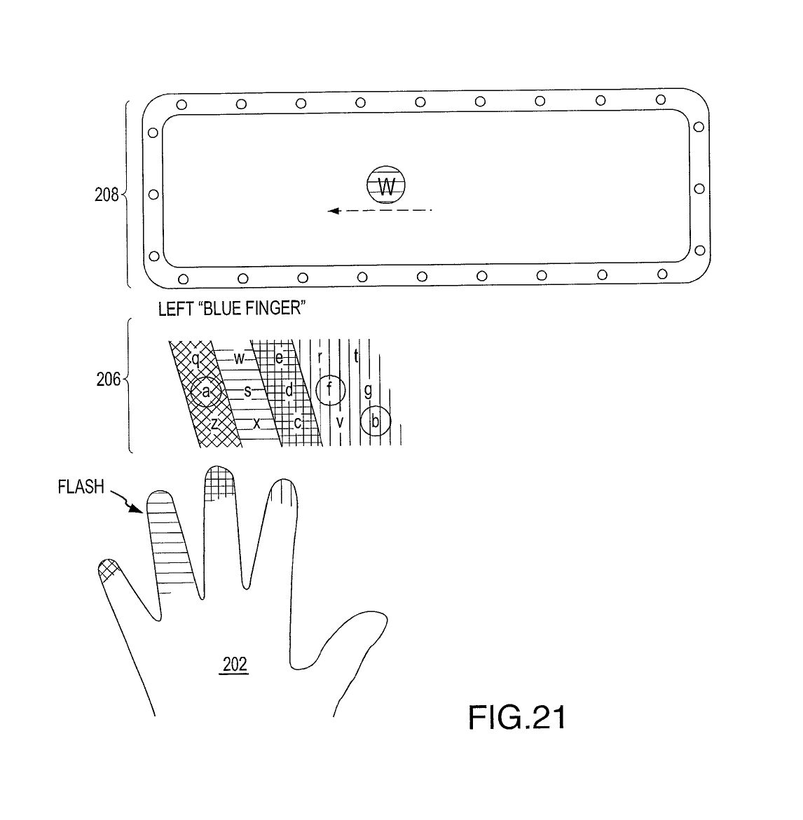

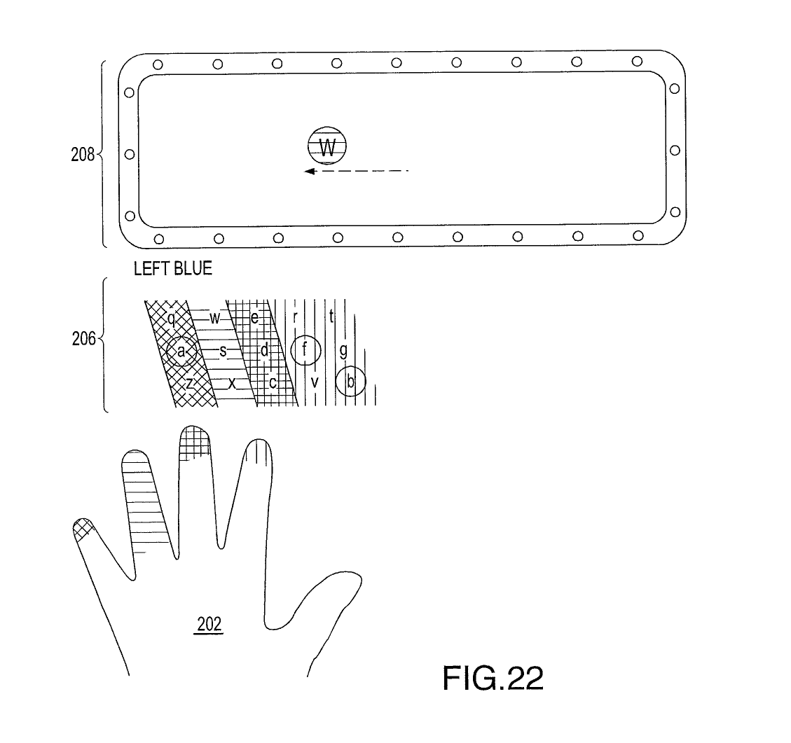

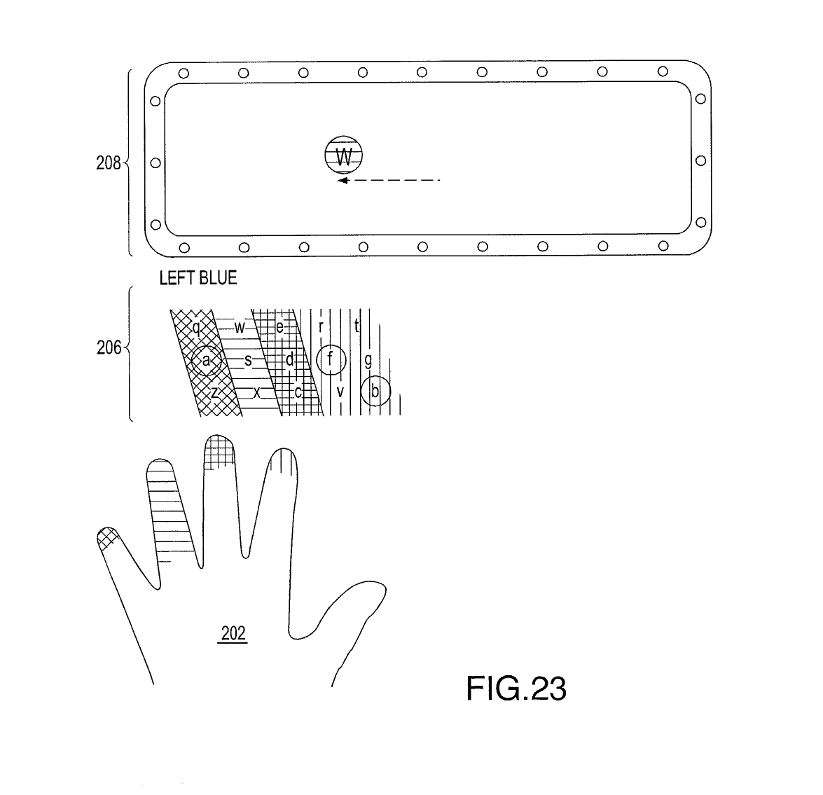

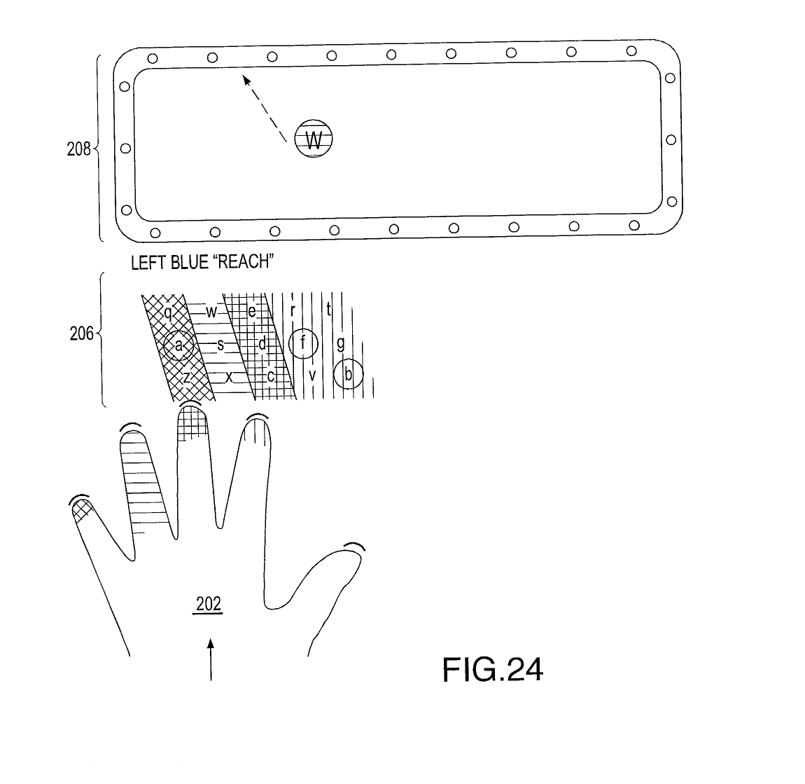

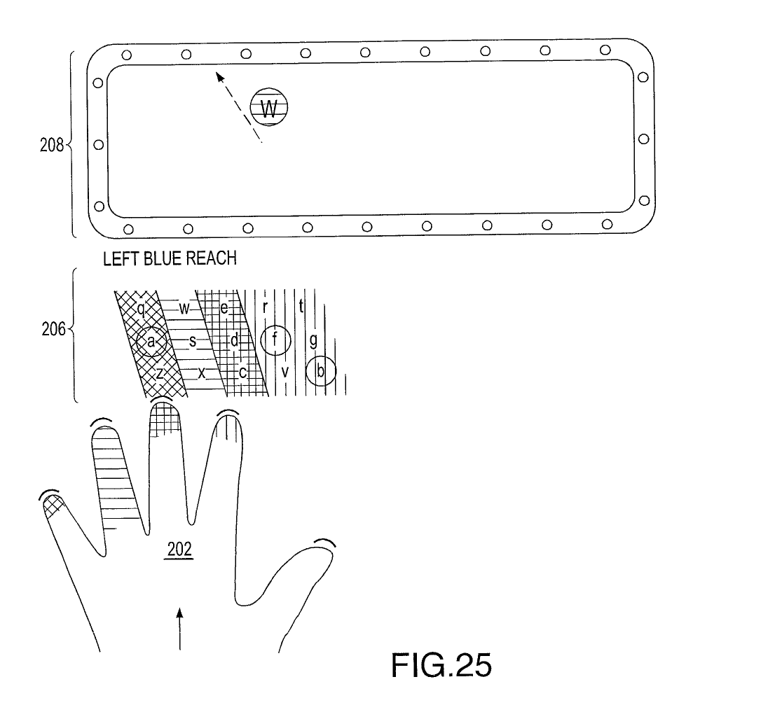

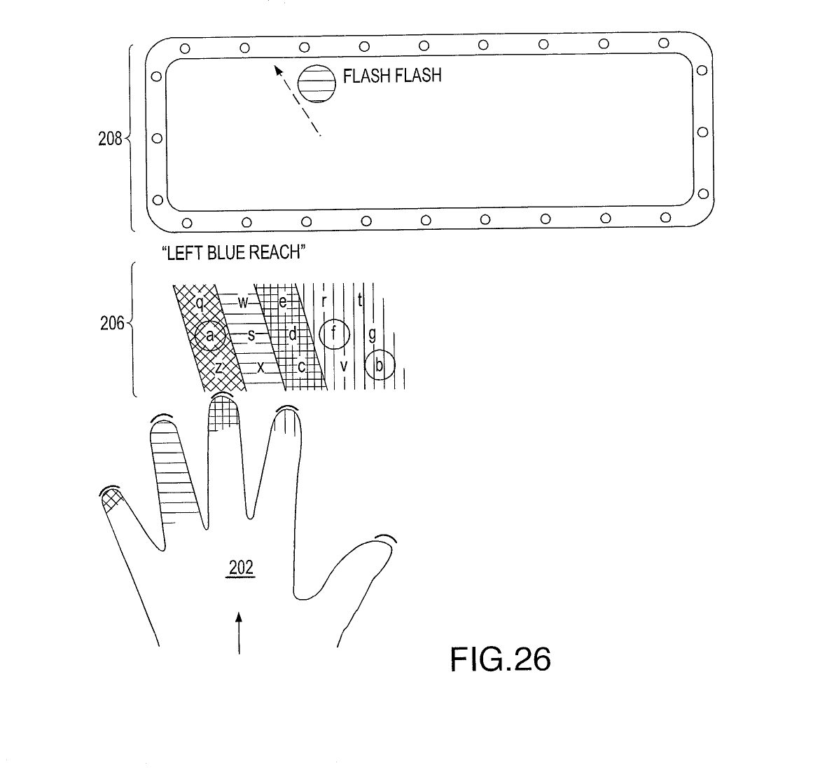

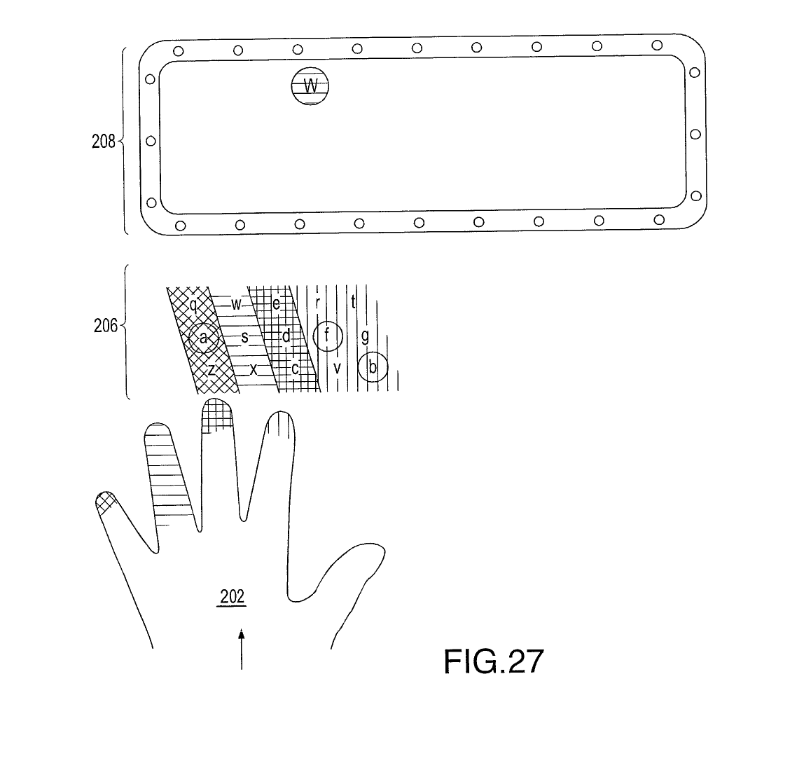

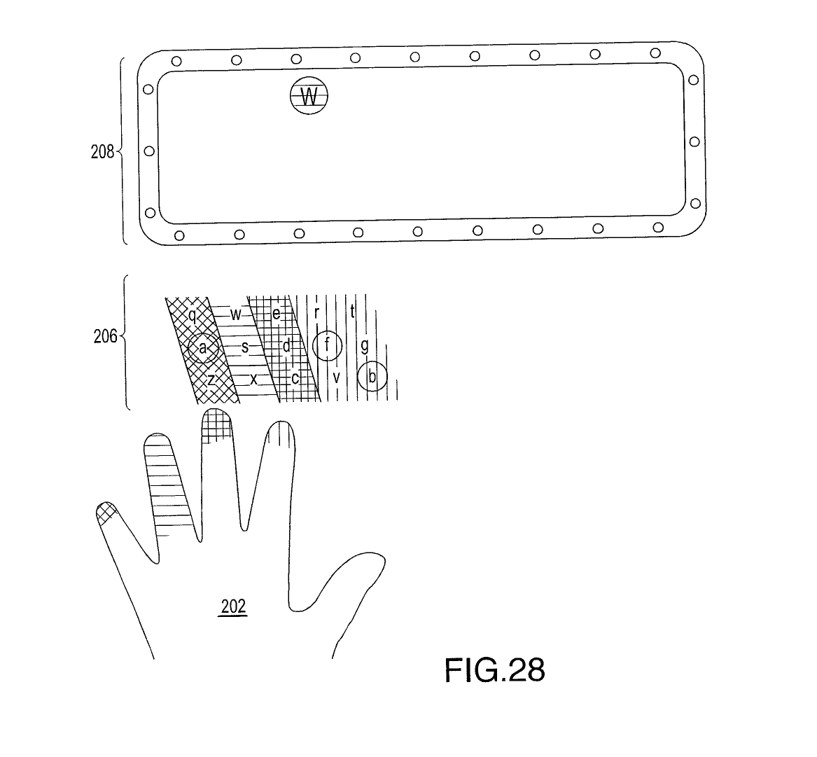

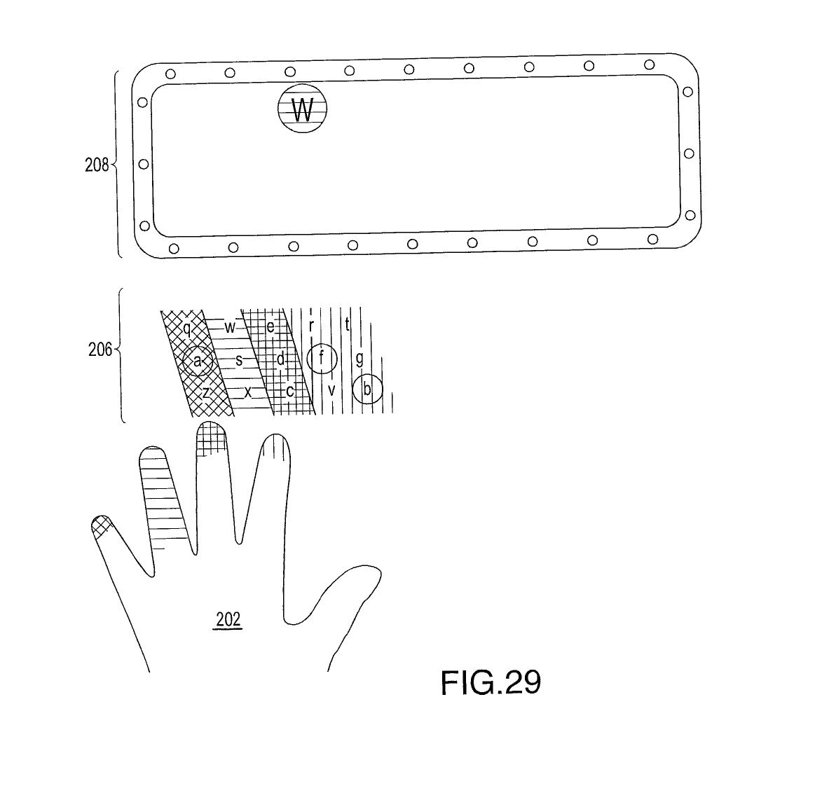

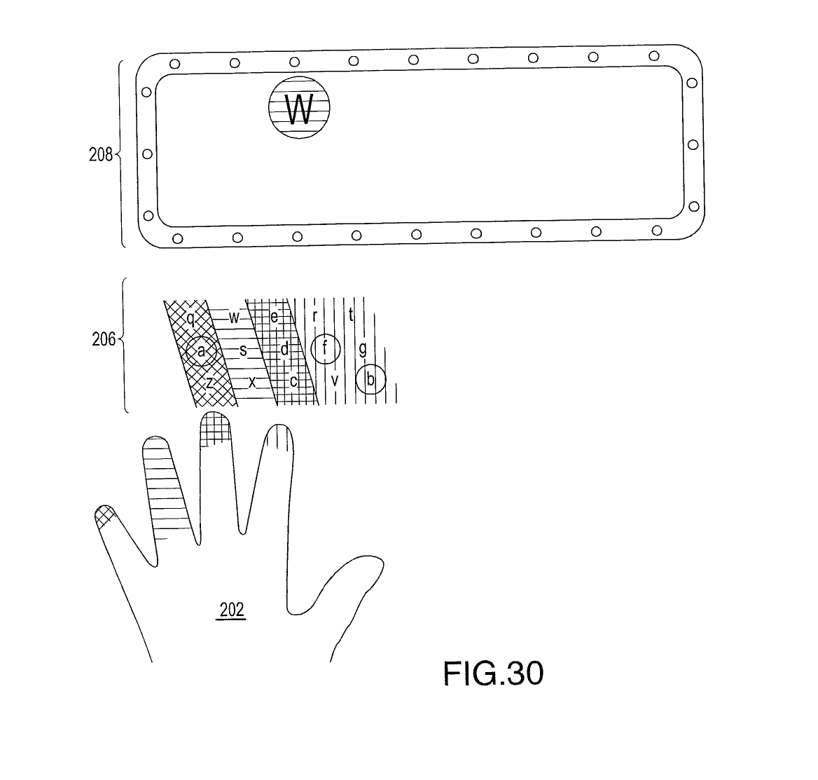

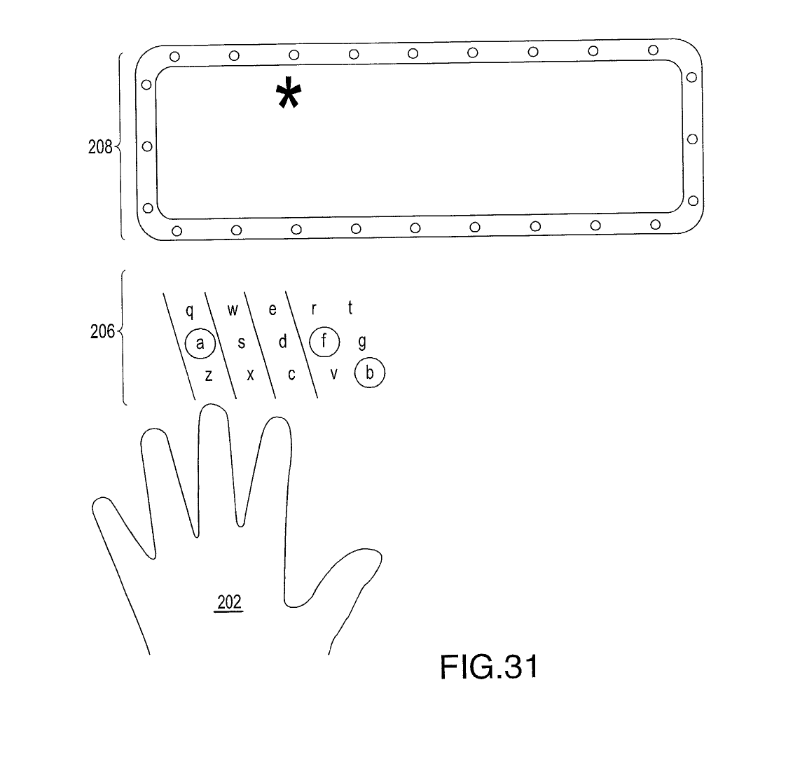

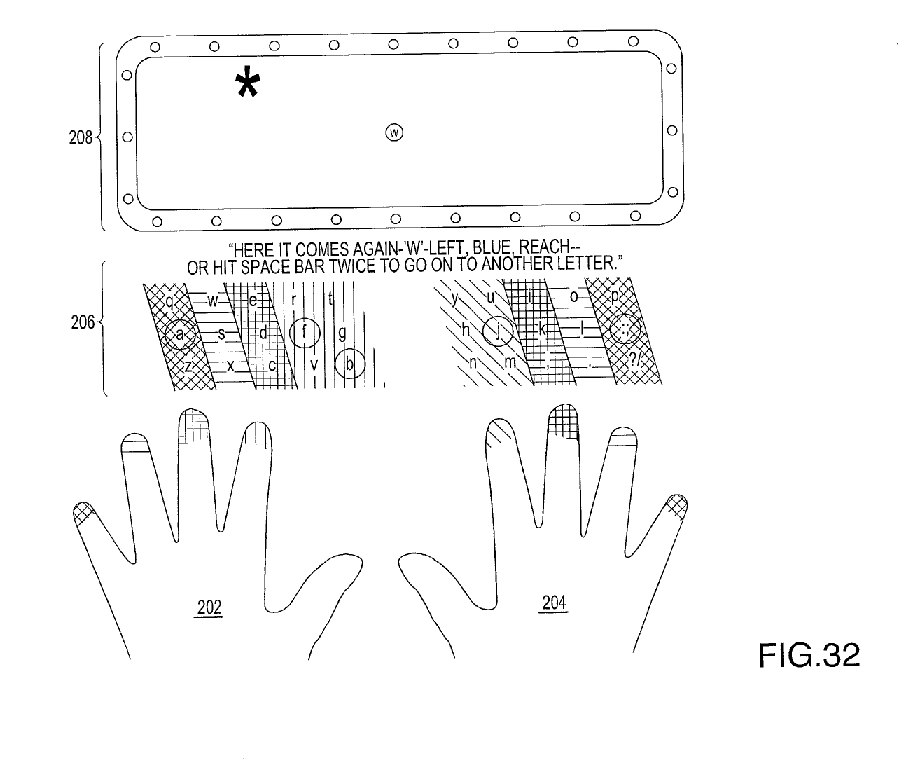

The “asteroids,” with the letter to be typed on their face, may start in the middle of the screen (FIG. 16) and get larger as they come closer (FIGS. 17-18). Then, depending on the letter, they move toward the left or the right (for example, corresponding to the position of the key corresponding to the letter to the left or right of the center of the keyboard) (see FIGS. 19-23), then changing color (FIGS. 21-28) to the color corresponding to the proper key on the keyboard (and the proper finger for depressing the key). Eventually (FIG. 24) the letter may move up or down to a position on the viewing port 208 corresponding to the position of the key on the keyboard. The asteroid may flash (FIG. 26) or grow bigger (FIGS. 27-30) before ‘exploding’ or “colliding” with the viewing port 208 (FIGS. 31-32). Of course, if the asteroid is destroyed prior to reaching its ultimate destination, the asteroid may be erased at that time and one or more other asteroids may be presented to the player. For example, if learning to type the word “tag”, a first asteroid may be erased upon proper depression of the “t” key on the keyboard but additional asteroids may follow for the remaining letters of the word. As the asteroid (or other object) progresses toward its final destination, verbal, audio or textual prompts may provide “hints” to the player. For example, a synthesized voice mail say “left hand”, “blue”, or “reach” for the letter “w”. In addition (or alternatively) the asteroid may change to the relevant color.

The principle of the game may be to actually teach the correct finger to use rather then just offer a set of practices that have objects, in random positions, to be eliminated by keystrokes. In various embodiments, the game does not admonish the student for an incorrect finger choice. Rather, the game may give clues to the correct finger choice by where the misfired laser shoots and it encourages trial and error to develop typing reflexes. The software has seven separate parts to learning the correct key:

1) the letter to be typed may be displayed and spoken, or musical or other tones corresponding to the letter could be played

2) the word or series of letters to be typed may be displayed

3) an underline may follow along under the word or series of letters

4) the directions may be printed and spoken

5) the directions may be indicated by the movement and color of the “asteroid”

6) the directions may be shown by the movement of the hand and color of the finger

7) the directions may be pictured on a representation of the keyboard

If an “asteroid” makes it through and hits the “viewing port,” a small crack in the port may develop. Some number of cracks (such as 10 cracks) may result in the “viewing port” being destroyed and/or the end of the game. An action by the player, such as hitting the space bar three times, may start a new game and restore the “port.” In alternate embodiments, the player loses a “life”, a token or the like. When all lives, tokens, etc. are expended, the game may be restarted or terminated, as appropriate.

Various embodiments may include various counters to indicate:

1) how fast the student is typing

2) how much more of the lesson is remaining

3) how many cracks remain until the “port” gets blown out

4) how many times the “port” was blown out during this session

5) other information as appropriate

Various embodiments may include choices for:

1) difficulty level

2) lesson

3) scenario for the game (asteroids, butterflies, etc.)

4) other information as appropriate

To simplify the description of the exemplary embodiments, the invention is frequently described as pertaining to a system of teaching typing that involves shooting asteroids or other objects. It will be appreciated, however, that many applications of the present invention could be formulated. For example, instead of shooting asteroids, any other object could be shot, destroyed, lasered, targeted, altered or otherwise focused upon. Similarly, other versions of a game could be formulated with other objectives. For example, instead of shooting at an object, a butterfly or bird could be netted, or a vehicle could be driven down a road, or any other objective could be used. In such embodiments, the words “asteroid, viewing-port and space” could just as easily be “butterfly, butterfly-net and meadow” if the game were to be set up for people that have an aversion to blasting asteroids.

Various embodiments of the invention may be distributed and executed in different ways. For example, a conventional software application may be stored on a diskette, CD-ROM or the like and distributed to users via retail outlets, wholesale outlets, mailings, and the like. Alternatively, a networked version of the application could be formulated using, for example, the Java programming language available from Sun Microsystems of Mountain View, Calif. or the Visual Basic, Visual C++ or Visual J++ languages available from the Microsoft corporation of Redmond, Wash., or the Shockwave or Flash multimedia environments available from the Micromedia Corp. In such embodiments, the application may be run in a web browser (such as the Navigator browser available from the Netscape corporation of Mountain View, Calif. or the Internet Explorer browser available from Microsoft) from a server on the Internet World Wide Web (or another suitable network). In such embodiments, users may browse to a web server, provide payment information to the server, and download an applet or other executable file to play the game described above. Alternatively, various instructions may be executed on the server and screen updates or other information may be suitably transferred to the clients' browser, as appropriate.

Versions of the program may support any language or keyboard style (e.g., “qwerty”, Dvorak, etc.).

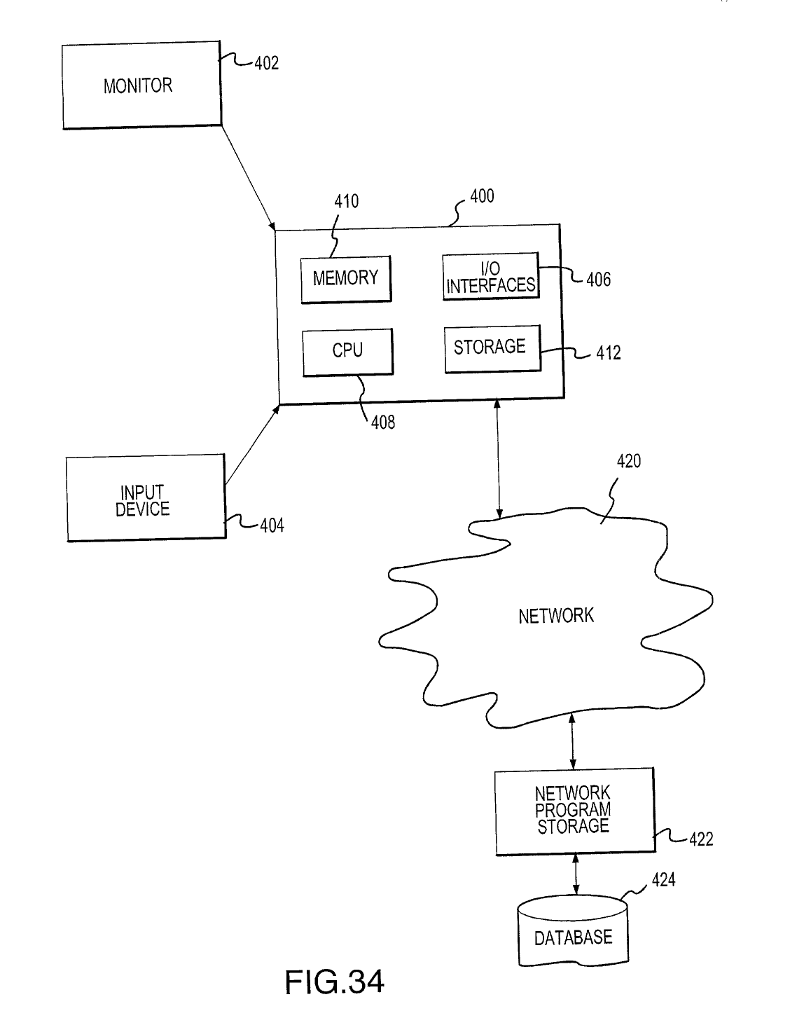

FIG. 34 is a flowchart showing an exemplary method of the present invention for teaching typing using a computer game. Once fingers are assigned to keys on a keyboard and color coding is assigned to the fingers of the right and left hand as well as the keys they are associated with, the game begins in step 300. This method may be used to teach the typing of letters, words, phrases and/or sentences but for simplicity in explanation, reference will be made to the teaching of a letter, such as the letter “w” shown in the display screens illustrated in FIGS. 16-30.

A letter, such as the letter “w”, is projected or shown in a viewing port 208 (See FIG. 16) in step 302. The letter is viewed by a user playing the game or using the teaching method and a predetermined amount of time is allowed for the user to make a keystroke in step 304. In step 306, a determination is made as to whether a keystroke was depressed within the allotted time period. If not, an additional predetermined time period may be made available in step 308 for responding with a keystroke. If additional time is made available in step 308, another predetermined time period is set for response in step 310 and the program waits again for a keystroke to be depressed in step 304. This cycle of allowing additional time for response may be repeated as often as desired and variable time periods may also be set by preprogramming these variables into the computer system as a predetermined recipe. If no additional time for response is allowed in step 308, the response is counted as an incorrect depression and the viewport becomes cracked or damaged (in the instance of a game where the letters are pictured as asteroids that are directed to a ship and which must be destroyed to save the ship) in step 312.

If a keystroke is depressed in step 306, a determination is made as to whether the correct key was depressed in step 314. If the proper key was depressed, the letter (which may be pictured in the form of an asteroid in one video game example) is destroyed in step 316 and the program returns to step 302 to show a new letter in the viewing port. It is important to note that when the correct key is depressed in step 314, the letter is preferably obliterated or destroyed in step 316 by way of visual and audio stimuli. The addition of the audio stimulus to the visual stimulus is important in that it provides another sensory intake to reinforce that the correct reflex was accomplished in selecting the correct key.

If it is determined in step 314 that the keystroke was incorrect, the viewport may be damages or cracked in step 312 as previously explained above or, the used may be provided with and audio and/or visual clue as to the correct keystroke in step 318. Examples of such clues can be found in FIGS. 19-26. Further, the number of additional audio and/or visual clues that may be provided to the user may be preset (i.e., only one clue) or preprogrammed into the computer game as part of a recipe (i.e., when the incorrect key is depressed, the loop will repeat to provide additional clues until multiple clues have been provided). After a clue has been provided in step 318, the program again wait for a predetermined period of time to allow the user to respond in step 304.

Once the viewport has been cracked or damaged in step 312, a determination is made as to the number of cracks or defects in step 320. If enough cracks or defects have occurred to destroy the viewport, the game ends in step 322. Alternatively, if there have not been enough defects or cracks to destroy the viewport, the program returns to step 302 where another letter is shown in the viewport.

It will be understood by those skilled in the art that many variations of those previously described steps may occur while still achieving the desired result in the same way. Moreover, a multitude of video game scenarios, characters and plots may be used to indicate correct and incorrect responses while still enabling the learning function of the game.

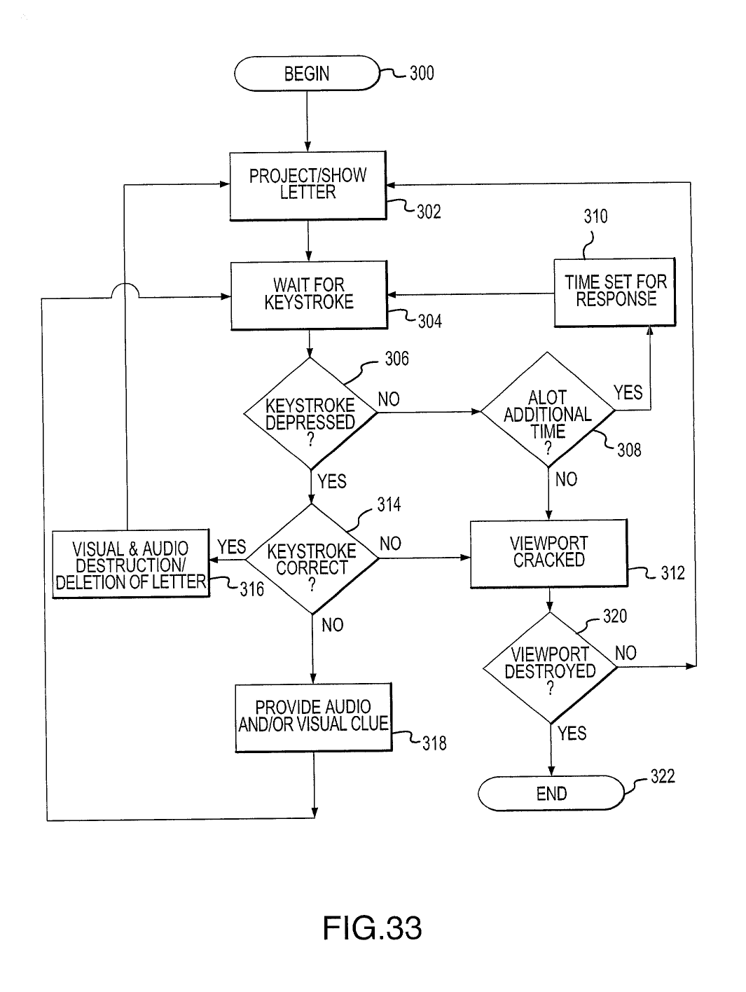

The system and method of the present invention is designed to flow back and forth from teacher to practice so that it goes as fast as the student goes without having to change any settings. Accordingly, by the nature of its design, the speed adjusts to suit each student/user/player based upon their response time. In other words, as the user speeds up, the game presents new targets at a faster pace. Once the user falters, the program switches to teaching mode to accommodate the incorrect response. As soon as the user depresses the correct key, the program resumes at whatever speed the user is capable of based upon their correct response time. Therefore, it should be noted that step 308 in FIG. 33 which allows for additional response time (and the various steps which, as a result, flow from it) is an optional feature which may be preprogrammed into the software as a recipe. This optional feature may be desired in those instances where beginners are unable to achieve reasonable response times and become virtually “locked” at a decision making point (i.e., where they need to make a key selection).

Without this optional feature, the computer game or program may include three different levels from which to select in order to begin a game. For example, upon beginning the game, a user may select a beginner, intermediate, or advanced stage. Once the selection is made and the game begins, a letter, word, phrase, or sentence to be typed will be presented and directions/clues will be given to direct the user to typing the proper key with the proper finger. The directions/clues will begin even if the user fails to immediately enter a keystroke. In the beginner version, the directions/clues will be very explicit and response time will allow the directions/clues to be introduced both visually and by audio. The intermediate level may allow sufficient time for the directions/clues to be given in an abbreviated version by audio and visually. By the time a user reaches the advanced stage, the directions/clues will come more quickly such that there may only be time for allowing the directions/clues to be given visually on the screen. The speed of the game will proceed based upon the reaction time of the user.

The lessons contained within the program may be made up of:

1) a fixed set of letters, symbols or words,

2) a customized set of letters, symbols, or words,

3) a random set of letters, symbols or words, or

4) a computer generated set of letters, symbols or words based in detected weaknesses where more practice is desirable.

The system and method of the present invention is further enhanced by the use of a shield to cover the keys. The topside of the shield comprises a representation of a keyboard having the keys colored in the pre-assigned colors associated with the proper fingers to be used for depressing the keys. During use, a user will see the top of the shield and a visual placement of his or her hands on that shield. Proper placement a user's fingers on the keys can be felt beneath the shield. In addition, certain keys may be modified with a rough surface to enhance the tactile sense of correct finger placement. Use of the shield enhances the system and method of the present invention by reinforcing “touch typing” instead of hand and eye coordination between the screen, eye and fingers.

A block diagram of a computer system used to carry out the method of the present invention for teaching typing is shown in FIG. 34. A main unit 400 is connected to a monitor 402 and a user input device 404 such as a keyboard and/or computer mouse. Main unit 400 includes input/output interfaces 406, a central processing unit (CPU) 408, an internal memory 410 and a storage 412. A software program carrying out the method of the present invention may run from main unit 400 or network 420 which may be used to download the computer program from network program storage 422. A network database 424 may also exist in association with the computer program of the present invention that is run through network 420 in order to store and evaluate data from the computer program regarding user speeds utilizing the program as well as successes and failures utilizing the program.

The corresponding structures, materials, acts and equivalents of all elements in the claims below are intended to include any structure, material or acts for performing the functions in combination with other claimed elements as specifically claimed. The scope of the invention should be determined by the appended claims and their legal equivalents, rather than by the examples given above.

What is claimed is:

1. A method of teaching typing, the method comprising the steps of:
a) pre-assigning fingers to match keys on a keyboard;
b) pre-assigning like colors to matching fingers and keys;
c) providing a predetermined set of lessons for learning how to type at least one of letters, words, phrases and sentences;
d) showing at least one of a letter, word, phrase and sentence on a screen;
e) allowing a user to depress one or more keys on said keyboard associated with said at least one of a letter, word, phrase and sentence;
f) determining whether said user correctly depressed said at least one of a letter, word, phrase and sentence shown on said screen;
g) providing video and audio acknowledgement of a correct depression or providing at least one of an audio and visual clue for an incorrect depression; and
h) repeating steps e through g until said user either achieves a correct depression or accumulates a predetermined number of incorrect depressions.

2. The method of claim 1 further comprising the step of selecting from two or more levels of skill prior to step d.

3. The method of claim 2 further comprising the step of automatically adjusting the speed at which the at least one clue is given in step g based upon a user's reaction time for correctly depressing a key.

4. The method of claim 1 further comprising the step of providing at least one of a visual and audio demerit for each incorrect depression wherein a predetermined number of demerits will end the showing of said predetermine set of lessons.

5. The method of claim 1 wherein said method comprises a computer game wherein each of said steps may be carried out with a variation of audiovisual graphics.

6. A computer readable medium having instructions stored thereon, wherein said instructions are configured to execute the method of claim 1.

7. A system for implementing a method for teaching typing comprising:
a software program for teaching typing utilizing the method of step 1;
at least one of a main unit and network capable of running said software program;
a monitor for viewing the images required for utilizing the software program; and
an input device for inputting the data required for utilizing the software program.

8. The system of claim 6 wherein said software program is a computer game which generates at least one of an audio and visual response.
